(19) United States
(12) Patent Application Publication
(10) Pub. No.: US 2023/0194468 A1
(43) Pub. Date: Jun. 22, 2023

(54) MEASURING SYSTEM

(71) Applicant: Analytik Jena GmbH, Jena (DE)

(72) Inventors: Heiko Henneberg, Plaue (DE); Marcel Freundel, Ilmenau (DE); Christiane Ehrling, Ilmenau (DE); Sophia Kaufmann, Rudolstadt OT Teichel (DE)

(21) Appl. No.: 18/069,758

(22) Filed: Dec. 21, 2022

(30) Foreign Application Priority Data
Dec. 21, 2021 (DE) 10 2021 134 602.9

(51) Int. Cl. G01N 27/42; G01N 27/44

(52) U.S. Cl. CPC G01N 27/423; G01N 27/44

(57) ABSTRACT

The present disclosure describes a measuring system, comprising: a housing; a first chamber formed in the housing; arranged in the first chamber, a measuring cell, which includes a container embodied for receiving an electrolyte and at least one electrode for potentiometric and/or amperometric measurements, wherein the at least one electrode has a first section, which is arranged within the container, and a second section, which extends out from the container into the first chamber; and a temperature regulating apparatus, which is embodied to produce a temperature-controlled gas stream moving through the first chamber and flowing around the measuring cell, especially the container and the section of the at least one electrode extending from the container lid into the first chamber.

### CROSS-REFERENCE TO RELATED APPLICATION

The present application is related to and claims the priority benefit of German Patent Application No. 10 2021 134 602.9, filed on Dec. 23, 2021, the entire contents of which are incorporated herein by reference.

### TECHNICAL FIELD

The present disclosure relates to temperature regulatable measuring systems.

### BACKGROUND

In conventional measuring systems, which are applied, for example, for analysis of samples, in many cases, measuring cells are used that include a container, which is intended for receiving an electrolyte, and electrodes, which extend at least partially into the container, such that they extend in measurement operation into the electrolyte. The electrodes of such a measuring system can be applied for potentiometric or amperometric measurements, e.g., to determine analytical parameters directly from the potentiometric or amperometric measurements. Amperometric or potentiometric measurements can also be applied in titration methods, where they serve for indication, e.g., determining an endpoint of a titration. A special case here is coulometric titration, in the case of which ions serve as reactants of the titration (also referred to as titrants). Measuring systems based on a titration, e.g., coulometric measuring systems, are utilized, for example, in elemental analysis systems, to ascertain the sulfur or chlorine content of a sample. An elemental analysis system adapted to determine the chlorine content of a sample coulometrically is described, for example, in EP 1837652 A2.

Amperometric and/or potentiometric measurements, e.g., in coulometric measuring methods, are greatly influenced by temperature changes such that a thermostat control of the measuring cell, especially the contained electrolyte and electrodes, is desirable to achieve sufficient accuracy of measurement and to prevent drift of the measured values resulting from temperature changes of the environment. Usually, the heating or cooling of the container of coulometric measuring cells containing the electrolyte is by actuators, which are in contact with the container wall or a jacket of the measuring cell. Thus, for example, in the utility model G 9115947.4, an apparatus is described for selective coulometric determining of volatile compounds by means of isothermal distillation and absorption at equal temperature. The apparatus includes an electrolysis chamber with stirrer, generator electrode, counter electrode, reagent supply as well as a flow detector, and a distillation chamber connected with it by a transfer passageway, plus gas and sample supply, and reagent supply, wherein the two chambers are surrounded by a temperature-controlled jacket.

In other coulometric measuring systems known in the state of the art, the electrolyte accommodated in the container of the measuring cell can be cooled, for example, via the container wall or a surrounding measuring cell basic body to lessen evaporation effects. Also, a heating of the electrolyte via the container wall or a surrounding measuring cell basic body is possible. This cooling or heating of the container wall by means of actuators directly acting on it has the disadvantage that thermal contact resistances lead to delays in the temperature control.

An additional problem is that the electrodes of the measuring cell have a frequently nonnegligible part of their total length extending from the container containing the electrolyte out into the environment. The temperature control of such measuring cells is, consequently, problematic when done with conventional means because changes of the ambient temperature influence the control and bring about an undesired drift of the measured values.

### SUMMARY

An object of the present disclosure is to provide a measuring system for the technical field of the present disclosure having improved means for temperature regulation of the measuring cell. This object is achieved by a measuring system according to the present disclosure. Advantageous embodiments of such measurements systems are also disclosed.

A measuring system according to the present disclosure comprises: a housing; a first chamber formed in the housing; a measuring cell arranged in the first chamber, which measuring cell includes a container embodied for receiving an electrolyte and at least one electrode for potentiometric and/or amperometric measurements, wherein the at least one electrode has a first section, which is arranged within the container, and a second section, which extends from the container into the first chamber; and a temperature regulating apparatus, which is embodied to produce a temperature-controlled gas stream moving through the first chamber and flowing around the measuring cell, for example, the container and the section of the at least one electrode extending from the container lid into the first chamber.

Because the container with the at least one electrode is flowed around by the temperature-controlled gas stream, assured is that the temperature-controlled gas stream acts essentially on all components of the measuring cell, and, as a result, within a short period of time a uniform temperature distribution is obtained in the measuring cell. It is found that, in the case of temperature regulation by means of a gas stream flowing around the measuring cell, after reaching a target temperature, an improved temperature homogeneity is obtained compared with the above-described systems of the state of the art, in the case of which the temperature regulation of the measuring cell occurs by means of actuators, which act directly on contact areas of the measuring cell housing. External thermal influences are intercepted at the system boundary and thus do not reach the measuring cell. This also eases control of the temperature of the measuring cell with the electrolyte and electrodes contained therein during operation and lessens measurement error or measured value drift as a result of temperature changes of the environment.

The at least one electrode of the measuring cell can be an electrode of a potentiometric measuring chain or an electrode of an electrode system for amperometric measurements. As an electrode of the potentiometric measuring chain, the electrode can be, for example, a reference electrode or a sensor electrode.

In an embodiment, the measuring system can serve for direct potentiometric or amperometric measurement of a measured variable of an analysis. In an additional embodiment, the measuring system can be embodied for determining an analysis measured variable based on a titration, wherein the endpoint of the titration is ascertained by means of a potentiometric or amperometric measuring.

For example, the measuring system can be embodied as a coulometric measuring system, for example, for coulometric titration of an analyte in the electrolyte, and can comprise a generator anode arranged at least sectionally in the container and a generator cathode arranged at least sectionally in the container for production of the titrant.

In an alternative embodiment, the measuring system can be embodied for titration of an analyte in the electrolyte by addition of a liquid or gaseous titrant into the measuring cell. In such case, the measuring cell can have a titrant supply line communicating with the container.

In an embodiment, the container can have a container lid, for example, a removable container lid, for closing the container. The at least one electrode of the measuring cell can extend through the container lid from the container into the first chamber.

In an advantageous embodiment, the temperature regulating apparatus for regulating temperature of the gas stream includes, arranged outside of the first chamber, a first heat exchanger, which is embodied to be flowed through by the gas stream, in such a manner that the gas stream is led in a circulatory system extending through the first chamber and the first heat exchanger. For example, the gas stream can come into the first chamber via a gas inlet, flow around the measuring cell in the first chamber and be led back out of the first chamber and into the first heat exchanger via a gas drain. Alternatively, the gas stream can move in the reverse direction.

In an embodiment, the circulatory system of the temperature-controlled gas stream is not hermetically sealed, wherein the gas flowing in the circulatory system is air from the first chamber, or surrounding air. Alternatively, the temperature-controlled gas stream can, however, also be an inert gas, e.g., nitrogen, argon or helium. In such case, the circulatory system can be sealed from the environment of the housing of the measuring system such that no surrounding air gets into the temperature-controlled gas stream, and no gas of the temperature-controlled gas stream reaches the environment.

The temperature regulating apparatus can have a flow passageway with a first end and a second end, wherein the first end opens in a first region of the first chamber through a wall bounding the first chamber, and wherein the second end opens in a second region of the first chamber spaced from the first region and through the wall bounding the first chamber, and wherein the temperature regulating apparatus further includes, arranged in the flow passageway, at least one air mover, which is adapted to move gas through the flow passageway, wherein the first heat exchanger is so arranged in the flow passageway that gas moved through the flow passageway by means of the air mover flows through the first heat exchanger.

The first region can be an upper region of the first chamber, and the second region can be a second region of the first chamber arranged below the upper region. The first and second regions can, however, in an alternative embodiment, be arranged spaced horizontally from one another at the same height.

The temperature regulating apparatus can have a cooling device for removing heat from the first heat exchanger and/or a heating device for delivering heat to the first heat exchanger.

In an advantageous embodiment of the measuring system, the cooling device and/or the heating device can comprise at least one Peltier element, e.g., a thermoelectric cooler/heater. Alternatively, the cooling device can comprise a heat pump, e.g., embodied as a compressor, densifier or condenser system, or an evaporation cooling system.

The temperature regulating apparatus can have a second heat exchanger, which is in thermal contact with the cooling device and/or the heating device. If the cooling device or the heating device has a Peltier element, the second heat exchanger can be in thermal contact with the Peltier element. In the case in which the temperature regulating apparatus is embodied as a cooling device, the hot side of the Peltier element can be in thermal contact with the second heat exchanger, which is adapted to lead heat away from the Peltier element, to increase the efficiency of the cooling effect of the first heat exchanger on the gas stream flowing through the first heat exchanger.

The temperature regulating apparatus can have a means for producing a fluid flow in thermal contact with at least one contact area of the second heat exchanger. The fluid stream can comprise a gas or liquid flow. The means for production of the fluid flow can be, e.g., an air mover, a fan or a pump.

In an advantageous embodiment, the second heat exchanger is arranged within the housing in a second chamber separated from the first chamber. The means for producing a fluid flow, e.g., the air mover, fan or pump, can be embodied to transport air from the environment outside of the housing into the second chamber to the second heat exchanger and then back out of the second chamber. Such an embodiment may be advantageous when the temperature regulating apparatus serves for cooling of the gas stream flowing around the measuring cell. In such case, the temperature regulating apparatus includes a cooling device, by which heat is removed by means of the second heat exchanger and the fluid stream flowing through the second heat exchanger. An especially efficient removal of heat is implementable in economic manner, in that the means for production of the fluid flow brings in cool air from the environment of the second chamber and from the environment of the housing.

The measuring system can have a control electronics, which is adapted to control the temperature regulating apparatus, to regulate temperature of the gas stream. The control electronics can be part of a device control of the measuring system and/or an electronic computer unit, which is connected with electrodes and/or sensors of the measuring system, to control the measuring system and to register measured values and process such.

In an advantageous embodiment, the measuring system can have, arranged in the temperature-controlled gas stream, at least a first temperature sensor, which is connected with the control electronics, to output measurement signals to the control electronics. The control electronics can be adapted to set and/or to control temperature of the gas stream based on the measurement signals of the at least a first temperature sensor.

When the measuring system includes a control electronics, which is adapted to control the temperature regulating apparatus, to regulate temperature of the gas stream, and includes, arranged in the temperature-controlled gas stream, at least a first temperature sensor, which is connected with the control electronics, to output measurement signals to the control electronics, the measuring system can, advantageously, have at least a second temperature sensor, which is arranged during operation of the apparatus in the fluid stream, which is in thermal contact with the second heat exchanger. The second temperature sensor can likewise be connected with the control electronics, to output measurement signals to the control electronics. Such can be adapted, based on the measurement signals of the at least a first and the at least a second temperature sensor, to set and/or to control temperature of the gas stream.

By one or more temperature sensors, which can be arranged both in the gas circulatory system, which passes through the first chamber, and along which the temperature-controlled gas stream flows during operation, as well as also in the fluid flow path, along which the fluid stream flows in the second chamber during operation, the control electronics can monitor the actual conditions and via control loops specify the setpoints for the power control of the temperature regulating apparatus, e.g., the cooling device, or the Peltier element and/or for the control of the rotational speeds of the air movers, fans or pumps in the gas or fluid stream and therewith implement the temperature control by comparison with setpoints.

In an advantageous embodiment, the measuring system includes, comprised of one or more parts, a covering, which is secured in such a manner releasably to a wall of the first chamber that it surrounds the measuring cell, e.g., the container and the section of the at least one electrode extending out of the container into the first chamber. The covering is so embodied that the temperature-controlled gas stream flows through the space within the first chamber surrounded by the covering. The covering can, in such case, direct the gas stream, such that it flows around the measuring cell and so enables the setting or controlling of a stable temperature of the measuring cell and of the therein contained electrolyte and electrodes with little lag time. In an embodiment, the first and second ends of the above-mentioned flow passageway can open into the space surrounded by the covering. The covering does not, in such case, have to seal the space surrounded by it hermetically.

The covering can have an opening, which is preferably arranged above the measuring cell and through which in the case of applied covering a liquid standard can be dosed, or metered, into the container of the measuring cell. The measuring system can include a dosing line, which is led through the opening to a liquid inlet of the measuring cell, e.g., a liquid inlet in the above-mentioned container lid of the measuring cell.

In measurement operation, e.g., in the case of the coulometric determining of sulfur, chlorine or various halogens (e.g., adsorbable organic halides (AOX)) as analytes in a measured gas flow, the measuring cell can be flowed through by the measured gas stream, e.g., a carrier gas stream containing the one or more analytes. The measuring cell can have for this a gas input opening into the container of the measuring cell and a gas output, e.g., a gas output arranged in the container of the measuring cell, wherein the gas output is connected with a gas drain leading out of the first chamber. The measured gas flow represents in conventional coulometric measuring systems a further disturbing variable, which can influence the temperature setting in the measuring cell. This disturbing variable is compensated by the temperature regulation of the measuring cell by means of the temperature-controlled gas stream.

For example, in the case of application of the measuring system in the form of a coulometric measuring system in an analytical device for quantitative determining of halogens or AOX in a sample, such as described above, the sample is burned and hydrogen halide HX (e.g., HCl, HBr, HI) formed in such case transported in a measurement or carrier gas stream into the measuring cell and dissolved in an electrolyte containing acetic acid. The quantitative determining of the one or more halogens occurs by means of titration, e.g., coulometric titration (argentometry), in the electrolyte. To prevent that acetic acid vapors or other substances escape from the electrolyte out of the measuring cell via the gas output into the first chamber or into the environment, the gas drain can be connected with a suction system, e.g., a pump.

In an embodiment, the pump can transport the measured gas, or the carrier gas, through the measuring cell.

In an additional embodiment, the gas output of the measuring cell can be open to the first chamber, e.g., via a T-piece connecting the gas output with the gas drain. Alternatively, the opening can, e.g., in the case of an embodiment without the above-mentioned covering, open directly into the first chamber. This embodiment is advantageous when the measuring or carrier gas is moved by positive pressure or by means of a second pump (different from the pump of the suction system) through the gas supply line into the container of the measuring cell.

When, as mentioned above, the carrier gas forming the temperature-controlled gas stream is air, and the circulatory system, e.g., the covering and also the first chamber, in which the gas stream is led, is not hermetically sealed from the environment, the pump sucks during operation of the measuring system not only the measured gas (including possible reaction products) flowing through the measuring cell from the measuring cell, but also via the opening, e.g., the T-piece, gas from the temperature-controlled gas stream. Advantageously, involved, in such case, is only a small amount. In this way, it is assured, on the one hand, that substances from the gas stream from the measuring cell, such as the acetic acid, do not get into the first chamber and/or into the space of the first chamber surrounded by the covering. If the housing, or the first chamber, is not hermetically sealed, air from the environment can flow in, in order to replace the air withdrawn by the suction system from the temperature-controlled gas stream.

A control electronics of the measuring system, e.g., the above mentioned control electronics, can be adapted to set a gas flow of measured gas, e.g., carrier gas with the one or more analytes, through the gas input into the measuring cell, and to set a gas flow through the gas drain, in such a manner that the gas flow through the gas drain is greater, advantageously slightly greater, than the flow of measured gas through the gas input. The temperature control of the control electronics can be adapted for controlling the temperature of the temperature-controlled gas stream or the temperature of the measuring cell also to set the gas flow through the gas drain, in that it outputs a corresponding manipulated variable to the pump.

In all of these embodiments, the measuring system can have, arranged further downstream from the measuring cell, an adsorber unit, via which the measuring cell is connected with the interior of the first chamber, with the interior of an additional chamber within the housing or with the environment outside of the housing of the measuring system. The gas stream drained from the measuring cell flows in measurement operation through the adsorber unit, which is adapted to adsorb substances from the gas stream, e.g., vapors leaving the electrolyte, such as the above mentioned acetic acid or reaction products. The adsorber unit can contain, for example, activated carbon as adsorber. The adsorbed substances freed from the gas can then be discharged into the environment.

For mixing the electrolyte contained in the container of the measuring cell, the measuring system can have a stirrer, e.g., a magnetic stirrer. A driver of the stirrer can be located outside of the temperature regulated space, for example, outside of the first chamber or, when the mentioned covering is present, at least outside of the covering. In this way, the influence of the heat loss from the driver on the temperature of the measuring cell and the electrolyte contained therein is minimized.

The inventiveness of the present disclosure resides also in an elemental analysis system for quantitative determining of an analyte of a, for example, solid, liquid or gaseous sample, comprising: a combustion furnace; a combustion tube arranged in the combustion furnace for receiving and burning the sample; at least one gas line opening into the combustion tube; and a measuring system according to one of the above described embodiments, wherein the gas line is fluidically connected with a gas input of the measuring cell of the measuring system, in order to lead measured gas, for example, a carrier gas containing a reaction product of the analyte formed in the burning of the sample, from the combustion tube to the measuring system.

### BRIEF DESCRIPTION OF THE DRAWINGS

The present disclosure will now be described in the following description based on the examples of embodiments illustrated in the figures. In such case, equal reference characters refer to equal components of the parts displayed in the figures. The figures of the drawing show as follows:

FIG. 1 shows a schematic exemplary embodiment of the measuring system according to the present disclosure; and

FIG. 2 shows an elemental analysis system including the measuring system shown in FIG. 1.

### DETAILED DESCRIPTION

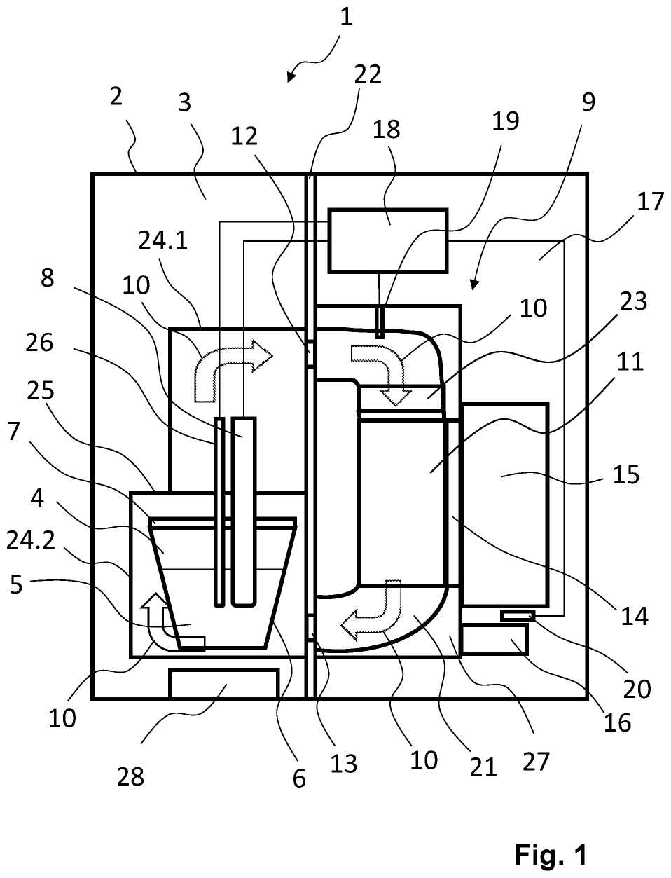

FIG. 1 shows in a schematic, longitudinal section an example of an embodiment according to the present disclosure of a measuring system 1, which serves for the quantitative determining of an analyte, e.g., a halogen, in a sample based on the principle of coulometric titration. Measuring system 1 includes a housing 2, which is divided into a plurality of chambers. Arranged in a first chamber 3 is a coulometric measuring cell 4 including a container 6 and a lid 7 closing the container 6. Container 6 serves for receiving an electrolyte 5, in which a coulometric titration occurs during operation of the measuring system 1. Arranged in the lid 7 are openings, which serve for the supply and draining of fluids or the introduction of electrodes. In the present example, there are two electrodes 8, 26. Electrode 8 in the present example of an embodiment is a potentiometric combination electrode of sensor and reference electrodes usable for the potentiometric indication of the coulometric titration. Alternatively, it is also possible to use reference and sensor electrodes separated from one another. Electrode 26 is a generator cathode, e.g., a platinum electrode. The generator-anode (not shown) can be disposed in the form of a silver disc on the floor of the container 6 or also an electrode in the lid 7. Possible also is an indication using an amperometric measuring method. The possible coulometric measuring methods for determining halogens and/or sulfur are known to those skilled in the art and are not described at length here. For registering measured values and for control of the titration, the electrodes 8, 26 are connected with a control electronics 18, which can be arranged in the housing 2 of the measuring system 1.

The electrodes 8, 26 extend each with a first section into the container 6, in such a manner that the first sections are immersed in an electrolyte 5 contained in the container 6. Rear, second sections of the electrodes 8, 26 extend from the lid 7 outside of the container 6 into the first chamber 3. The second sections of the electrodes 8, 26 are connected via electrical lines with a measuring circuit and/or the control electronics 18. Measuring cell 4 and the second sections of the electrodes 8, 26 are surrounded by a covering, which in the present example is formed of two boxes 24.1 and 24.2. The two boxes 24.1 and 24.2 are connected releasably with a partition 22, which separates the first chamber 3 of the housing 2 from a second chamber 17 of the housing 2. Boxes 24.1 and 24.2 as well as the partition 22 can advantageously be formed of a plastic of low thermal conductivity. This lessens the influence of a temperature change in the environment on the temperature of the measuring cell 4.

Arranged outside of the covering, in the present example below the second box 24.2 and the container 6, is a driver 28 of a magnet stirrer, which produces a magnetic field, which serves to cause a rod magnet present within the container 6 to rotate, to mix the electrolyte 7 contained therein.

Located in the second chamber 17 separated from the first chamber 3 via the partition 22 in the present example of an embodiment is an insulating housing 27 of a heat insulating material, e.g., plastic, in which a flow passageway 21 is embodied. The flow passageway 21 includes a first end, which communicates with the first chamber 3 via a first opening 12 in the partition 22. Equally, the flow passageway 21 includes a second end, which communicates with the first chamber 3 via a second opening 13 in the partition 22. Arranged within the insulating housing 27 in the flow passageway is a first air mover 23. First air mover 23 can comprise, for example, a ventilator, which during operation of the apparatus moves gas through the flow passageway 21.

Arranged within the flow passageway 21, moreover, is a first heat exchanger 11. The first heat exchanger 11 includes a body of a material of high thermal conductivity, e.g., a metal such as copper or aluminum. The body has a structure, in which, e.g., by a large number of ribs, a large number of flow receiving channels are formed, which can be flowed through by a gas stream passing through the heat exchanger 11, in such a manner that an as large as possible surface of the heat conducting body comes in contact with the through flowing gas to remove heat from the gas (cooling function) or to transfer heat to the gas (heating function).

In the present example of an embodiment, the first heat exchanger 11 is provided to cool a gas stream 10 flowing through the flow passageway 21. For removing heat from the body of the heat exchanger 11, one or more Peltier elements 14 are arranged at the periphery of the heat exchanger 11. The first side (cold side) is in heat conducting contact with the body of the material with high thermal conductivity. For removing heat, the cold side opposite, hot side of the one or more Peltier elements 14 is in heat conducting contact with a second heat exchanger 15, which can be embodied identically to the first heat exchanger 11. In the second chamber 17 at a first end of the second heat exchanger 15, a second air mover 16 is provided, which is embodied to produce, moving through the second heat exchanger 15, a fluid stream, which serves as fluid cooling for the active removal of heat from the hot side of the Peltier element via the second heat exchanger 15. In operation of the apparatus, the second air mover 16 moves fresh air from the outside of the housing 2 into the heat exchanger 15. Arranged upstream of the second heat exchanger 15 are other air movers (not shown), which transport the heated air outlet flow emerging from the second heat exchanger 15 out of the housing 2.

By means of the described apparatus, a temperature-controlled gas stream 10 through the first chamber 3 can be produced, which serves for setting or controlling a stable temperature of the measuring cell 4 and the electrolyte 5 contained in the container 6. In operation of the apparatus, the first air mover 23 arranged in the flow passageway 21 produces a gas stream 10 (shown by arrows in FIG. 1), which is led in a circulatory system, which extends through the flow passageway 21 and the first chamber 3 within the space surrounded by the covering 24.1 and 24.2. In flowing through the first heat exchanger 11, the gas stream 10 is cooled by means of the one or more Peltier elements 14 and, thus, brought to a desired temperature. In an alternative embodiment, the first heat exchanger can also serve for heating the gas stream 10 to set a desired temperature. In an additional, alternative embodiment, the gas stream 10 can also flow in the reverse direction, opposite to the direction indicated in FIG. 1 by the arrows.

Arranged in the flow path of the gas stream 10 in the present example is a first temperature sensor 19, which is connected with the control electronics 18, to output to the control electronics 18 temperature measured values of the gas stream 10. A second temperature sensor 20 is arranged in the region of the first end of the second heat exchanger 15. This second temperature sensor 20 lies within the flow path of a fluid stream produced by the second air mover 16 and which flows through the second heat exchanger 15. Also, the second temperature sensor 20 is connected with the control electronics 18, to output to the control electronics 18 temperature measured values produced by the second temperature sensor 20.

Gas stream 10 of the air cooled by means of the first heat exchanger 11 is so led through the insulating housing 27 and the removable covering 24.1, 24.2 that it flows around the measuring cell 4 and all electrodes and gas guide parts of the measuring cell. By means of the first temperature sensor 19, the control electronics 18 registers the temperature of the gas stream 10 and evaluates the registered measured values for controlling the temperature of the gas stream 10. For example, the control electronics 18 can compare the temperature of the gas stream 10 with a desired value stored in a memory of the control electronics 18. For adjusting the currently measured actual values of temperature to match the stored desired value, the control electronics 18 can be adapted to output actuating values for the power of the one or more Peltier elements 15 and/or of the one or more air mover 23, 16. In this way, the temperature of the gas stream 10 can be controlled to a constant value. Since the gas stream 10 flows around the parts of the measuring system 1 whose temperature is to be regulated, these parts in due course reach the desired temperature and then remain temperature stable. Resulting therefrom, a stable measuring system without temperature drift is achieved.

In an advantageous embodiment, the measuring cell 4, e.g., the container 6 and the reference electrode applied for indication, or, for the case, such as in the present example, that sensor and reference electrode are combined into a combination electrode 8, the body of the combination electrode 8, can be formed essentially of glass, which is advantageous for the transfer of temperature to the electrolyte 5 in the container 6 and to the internal electrolyte of the reference electrode.

By arranging the driver 28 of the magnet stirrer outside of the covering 24.2 such is thermally decoupled from the measuring cell 4, such that the power loss of the driver 28 has no or, at most, negligible influence on the temperature of the gas stream 10.

For maintenance purposes, the boxes 24.1, 24.2 of the covering are removable. In the present example, the boxes 24.1, 24.2 are, moreover, so embodied that all parts necessarily reachable in measurement operation are freely accessible. Thus, there is provided between the boxes 24.1, 24.2 an opening 25, via which samples can be supplied from outside of the covering into the measuring cell 4, without requiring that the boxes 24.1, 24.2 must first be removed. By fitting the covering to the lid 7 of the measuring cell 4 and to the partition 22, a certain degree of sealing of the circulatory system, within which the gas stream 10 forms, from the environment is achieved, which, together with the utilized materials with high thermal resistance, facilitates the control of a constant temperature of the gas stream 10.

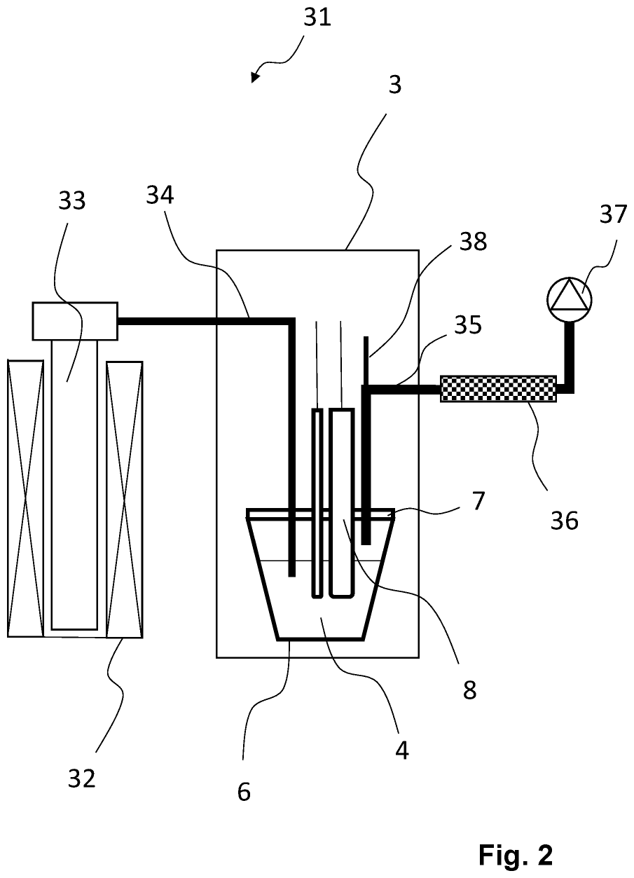

FIG. 2 shows schematically an elemental analysis system 31 using the measuring system 1 described based on FIG. 1. Parts of the measuring system 1, e.g., the housing chambers, the control electronics 18 and the means for producing and temperature regulation of the gas stream flowing around the measuring cell 4, have been omitted in FIG. 2 for reasons of perspicuity. Only the housing chamber 3 and the measuring cell 4 arranged therein are shown.

The elemental analysis system 31 includes a combustion furnace 32. Arranged in the combustion furnace 32 is a combustion tube 33, which is connected with the measuring cell 4 of the measuring system 1 via a gas supply line 34. Gas supply line 34 communicates with the interior of the container 6 through the lid 7 of the measuring cell 4. Extending through lid 7 is also a gas drain 35, which connects the interior of the container 6 with an adsorber unit 36. The adsorber unit 36 includes a chamber filled with activated carbon. Adsorber unit 36 is connected with a suction pump 37, which is embodied to move gas from the interior of the container 6 out via the gas drain 35 and through the adsorber unit 36.

In the present example of an embodiment, elemental analysis system 31 serves for determining chlorine in a sample. In the combustion furnace 32 in measurement operation, the sample contained in a combustion tube 33 is oxidized to gaseous reaction products using oxygen and argon, in variable parts, as carrier gas, wherein chlorine contained in the sample is converted to hydrochloric acid. The formed hydrochloric acid flows with the carrier gas stream via the gas supply line 34 into the measuring cell 4. Provided in the flow path of the carrier gas in such case can be other means (not shown), e.g., a carrier gas drying means, for isolation of the hydrogen chloride from other reaction products of the sample. The hydrochloric acid introduced into the electrolyte 7 is dissolved in the electrolyte 7 and quantitatively determined by means of coulometric titration. For this, the control unit 18 controls the measuring system for ascertaining the charge flowed through the generator electrodes up to detection of the endpoint of the coulometric titration by means of the potentiometric combination electrode 8. From this measured variable, the control unit 18 derives a measured value of the chlorine content in the original sample. The carrier gas stream is removed from the measuring cell 4 via the gas drain 35. Suction pump 37 serves, in such case, for moving the carrier gas. The part of the acetic acid used for the coulometric titration that leaves the measuring cell 4 with the carrier gas stream is adsorbed in the adsorber unit 36, such that the carrier gas downstream of the adsorber unit 36 can be discharged into the environment.

The carrier gas stream represents by its warming of the electrolyte 7 basically another disturbing variable, which, however, is compensated by the temperature regulation of the measuring cell with the gas stream 10. In the present example of an embodiment, another opening 38 is provided in the gas drain 35 e.g., in the form of a T. To achieve stable ratios, the suction pump 37 is controllable, advantageously by means of the control electronics 18. In operation, the suction pump 37 is so controlled that the suction flow, i.e., the gas flow through the gas drain 35, is somewhat greater than the flow of the carrier gas stream inlet by the gas supply line 34. In such case, the difference between the gas flow through the gas drain 35 and the flow through the gas line 34 should be selected as small as possible, such that only a small part of the gas forming the temperature-controlled gas stream 10 is sucked out. By sucking gas removed from the temperature-controlled gas stream 10, replacement is by gas from the environment, since the described circulatory system of the temperature-controlled gas stream 10 is not hermetically sealed from the environment.

The present disclosure is not limited to the illustrated examples of embodiments. The gas cooling of the measuring cell can be applied with similar advantages, for example, not only in an elemental analysis device for determining chlorine or sulfur, but, instead, also for other halogens, or the global parameters AOX (adsorbable organic halides, or adsorbable organically bound halogens) or AOF (adsorbable organic fluorine or adsorbable organically bound fluorine).

The here described temperature regulation of a measuring cell with electrodes in a measuring system can, moreover, be applied also in many other applications and is also not limited to the application for coulometric measuring cells and/or as part of an elemental analysis system. Also, the described temperature control by means of a gas stream can be applied for determining other parameters, e.g., arsenic, for Karl Fischer titratiton or in coulometric methods with mercury drop electrodes. It can also be used for temperature regulation of measuring cells for direct determining of analysis parameters by means of amperometric or potentiometric measurements.

1. A measuring system, comprising:
a housing;
a first chamber disposed in the housing;
a measuring cell disposed in the first chamber, the measuring cell including a container configured to receive an electrolyte and at least one electrode configured for potentiometric and/or amperometric measurements, wherein the at least one electrode includes a first section disposed within the container and a second section, which extends from the container and into the first chamber; and
a temperature regulating apparatus configured to produce a temperature-controlled gas stream moving through the first chamber and flowing around the measuring cell, including the container and the section of the at least one electrode extending from the container lid into the first chamber.

2. The measuring system of claim 1, wherein the at least one electrode is an electrode of a potentiometric sensor or is an electrode of an electrode system for amperometric measurements.

3. The measuring system of claim 1, wherein the measuring system is configured for coulometric titration of an analyte in the electrolyte and further comprises a generator anode disposed at least sectionally in the container and a generator cathode disposed at least sectionally in the container as to enable generating a titrant for the coulometric titration.

4. The measuring system of claim 1, wherein the measuring cell includes a titrant supply line in fluid communication with the container.

5. The measuring system of claim 1, wherein the container includes a container lid configured to close the container, wherein the at least one electrode extends through the container lid from the container into the first chamber.

6. The measuring system of claim 1, wherein the temperature regulating apparatus includes, disposed outside the first chamber, a first heat exchanger, which is configured enable the gas stream to flow therethrough such that the gas stream is led in a circulatory system extending through the first chamber and the first heat exchanger.

7. The measuring system of claim 6, wherein:
the temperature regulating apparatus includes:
a flow passageway with a first end and a second end, wherein the first end opens in a first region of the first chamber through a wall bounding the first chamber, and wherein the second end opens in a second region of the first chamber through the wall bounding the first chamber; and
at least one air mover disposed in the flow passageway, the at least one air mover adapted to move gas through the flow passageway,
wherein the first heat exchanger is disposed in the flow passageway such that gas moved through the flow passageway by the at least one air mover flows through the first heat exchanger.

8. The measuring system of claim 6, wherein the temperature regulating apparatus includes a cooling device configured to remove heat from the first heat exchanger and/or includes a heating device configured to supply heat to the first heat exchanger.

9. The measuring system of claim 8, wherein the cooling device and/or the heating device comprises at least one thermoelectric element.

10. The measuring system of claim 8, wherein the temperature regulating apparatus includes a second heat exchanger, which is in thermal contact with the cooling device and/or the heating device.

11. The measuring system of claim 10, wherein the temperature regulating apparatus has a means for producing a fluid flow in thermal contact with at least a contact area of the second heat exchanger.

12. The measuring system of claim 11, wherein the second heat exchanger is disposed within the housing in a second chamber, which is separated from the first chamber, and wherein the means for producing a fluid flow is configured to transport air from an environment outside the housing into the second chamber to the second heat exchanger and then back out of the second chamber.

13. The measuring system of claim 1, further comprising a control electronics configured to control the temperature regulating apparatus as to regulate a temperature of the gas stream.

14. The measuring system of claim 13, further comprising, disposed in the temperature-controlled gas stream, a first temperature sensor connected to the control electronics as to output measurement signals to the control electronics, and wherein the control electronics is configured to set and/or control the temperature of the gas stream based on the measurement signals of the first temperature sensor.

15. The measuring system of claim 11, further comprising:
a control electronics configured to control the temperature regulating apparatus as to regulate a temperature of the gas stream;
disposed in the temperature-controlled gas stream, a first temperature sensor connected to the control electronics as to output measurement signals to the control electronics; and
disposed in the fluid flow, at least a second temperature sensor, which is connected with the control electronics as to output measurement signals to the control electronics,
wherein the control electronics is configured to set and/or to control the temperature of the gas stream based on the measurement signals of the first temperature sensor and the second temperature sensor.

16. The measuring system of claim 1, further comprising, a covering, comprising of one or more parts, which is secured releasably to a wall of the first chamber such that the cover surrounds the measuring cell.

17. The measuring system of claim 16, wherein the covering includes an opening through which a liquid standard can be dosed, or metered, into the container of the measuring cell.

18. The measuring system of claim 1, wherein the measuring cell includes a gas input opening, into the container of the measuring cell, and a gas output, wherein the gas output is connected with a gas drain leading out of the first chamber.

19. The measuring system of claim 18, wherein the gas drain is connected with a suction system.

20. The measuring system of claim 18, wherein the gas output is open to the first chamber.

21. The measuring system of claim 20,
wherein a control system of the measuring system is configured to set a flow of measured gas through the gas input into the measuring cell, and to set a flow of gas through the gas drain, such that the flow of gas through the gas drain is greater than the flow of measured gas through the gas input.

22. An elemental analysis system for quantitative determining of an analyte of a sample, the system comprising
a combustion furnace;
a combustion tube disposed in the combustion furnace and configured to receive and burn the sample;
at least one gas line opening into the combustion tube; and
the measuring system of claim 1,
wherein the gas line is fluidically connected with a gas input of the measuring cell of the measuring system as to lead measured gas, including a carrier gas containing a reaction product of the analyte formed from a burned sample, from the combustion tube to the measuring system.
